(19) United States
(12) Patent Application Publication
(10) Pub. No.: US 2005/0218648 A1
(43) Pub. Date: Oct. 6, 2005

(54) Pipe or conduit collar

(76) Inventor: George Logue JR., Trout Run, PA (US)

Correspondence Address: Pamela A. Ruest, Esq.;McQuaide Blasko, 811 University Drive, State College, PA, 16801-6699, US

(21) Appl. No.: 10/633,452

(22) Filed: Aug. 1, 2003

(51) Int. Cl. F16L 35/00

(52) U.S. Cl. 285/18

(57) ABSTRACT

A pipe or conduit collar particularly used in the connection of piping or conduits to underground vaults such as those used for receiving and distributing fluids such as storm water and sewage and also electrical wires and cable. The collar is a flexible strip having a spine and two sides defining an “L” shaped cross-section and is used in situations where a loose fitting piping creates a roughly annular open section between the pipe exterior and the aperture receiving the pipe or conduit. The collar is installed around the pipe and flush with the outer wall of the vault. When installed, the collar blocks the annular clearance gap so that the area around the inlet and piping may be backfilled prior to the annular section being sealed. At a convenient time after backfilling, a seal (e.g. concrete mix) can be put into the annular clearance gap from access to the inside of the vault. In a preferred embodiment a series of slices or serrations all along one branch of the “L” allows the strip to be easily put in a circular shape during installation around the pipe with the unserrated side touching the pipe or conduit and the serrated side fanned out and flush against the inlet exterior, blocking the annular opening around the pipe or conduit.

### FIELD OF THE INVENTION

The invention relates to the installation of underground vaults having one or more conduit or piping connections. More specifically, the invention relates to pipe or conduit collars for improving the installation of such vaults and their connections.

### BACKGROUND OF THE INVENTION

Underground vaults are commonly used structures. Examples of some applications in which they are used include: (1) distributing utilities such as electricity and (2) collecting and distributing fluids such as sewage and storm water runoff. Such vaults typically have one or more conduit or piping connections for receiving or distribution wires, storm water, or sewage depending on the specific application of the vault. These vaults also typically provide access to the inside for maintenance purposes. Often this access is provided by a removable top that is flush with the ground when the vault is buried. These vaults are sometimes known as manholes, collection boxes, catch basins, inlet boxes, or distribution boxes to give a few examples. The vaults are frequently made of concrete, but can be made of other materials such as polymers.

In applications where such vaults are used to collect and/or distribute fluids they are generally used in situations where there is a need to distribute relatively large quantities of fluid at low pressure. Two primary examples are the management of storm water runoff and in the handling of sewage. In these applications, it is common to find the use of precast concrete distribution boxes or catch basins that are capable of receiving fluid and distributing it through one or more pipes. Some of these boxes are designed to receive fluid through a pipe and some are designed to received fluid via a grate positioned on top of the collection box as in the case of storm water runoff catch basins. Whatever the application, most of these vaults have to be installed underground in a process that requires the following four generic steps: excavating, positioning of the vault, connecting the pipe(s) or conduit(s), and backfilling.

A detailed description of one particular use of such vaults—the management of storm water runoff—will be instructive. A primary aim of storm water management involves collecting and distributing storm water in a controlled, environmentally responsible manner. Two main components of such systems are the inlet or collection box (i.e. catch basin) and the distribution piping. First, storm water runoff is collected. This is accomplished by specific site design that guides runoff to a collection point. At the collection point, a pre-cast concrete inlet or catch basin is buried flush with the immediate surrounding ground or roadway. The catch basin is typically a hollow cube or other shaped construction made of precast concrete or strong polymer. Catch basins have an open top upon which a grate (or some other restricting device) is placed to allow water to flow into the inlet while filtering out debris. These catch basins generally have solid bottoms and one or more circular holes in the sides for piping to distribute the collected storm water to a desired location. The size of such catch basins (and other vaults) can vary greatly from perhaps 2×4 ft up to 8×8 ft for cubic precast versions or up to 12×12 ft or even more for non-precast constructions. Similar sizes for round vaults are also known.

The second part of the system is the distribution piping. This piping can be made of pre-cast concrete, but can also be made of other material such as metal or polymer (e.g. PVC). The distribution piping is also buried underground as water flow is generally by gravity only. The piping may deliver the water to a collection pond or other area for allowing the water to seep into the subsurface or it may deposit the water into a sewage system or waterway.

Catch basins such as those just described for use in storm water runoff collection and distribution systems are somewhat time consuming and labor intensive to install. A somewhat simplified explanation of the installation process for such catch basins and other vaults is as follows: (1) a piece of heavy equipment (e.g. a backhoe) is used to excavate an area for the vault and also trenches for connecting piping or conduits, (2) the vault is placed in the ground, (3) the piping or conduits are fitted to the vault, (4) any openings between the vault and the piping or conduits are sealed (e.g. with concrete), (5) the seal is allowed to cure, and (6) the excavated area is backfilled with stone and/or earth. The sealing and curing step are the most relevant to the present invention and will be explained in a little more detail.

The circular holes placed in the catch basins (and other vaults) for receiving the piping are typically made somewhat larger than the piping intended to be connected. The diameter of the hole may be 2 inches or more larger than the diameter of the pipe. This excess is desirable in order to make it easier to place the piping inside the opening and to adjust alignment as such connections can be especially difficult to make with heavier objects such as these. This loose fitting piping creates an annular-like open area around the pipe when the pipe is inserted. Note that while the term “annular” is used herein to describe this open space between the outside of the conduit and the opening itself, the space may look more crescent shaped if the piping is actually resting on the opening or is otherwise not positioned concentrically with the opening via some support. Regardless of its shape, this annular open area must be blocked or sealed prior to back-filling the area or back-fill material may enter the box. The annular area is usually filled with a concrete mix or grout type material prepared to a mud-like consistency which later hardens for a good seal.

This process is fairly simple and straight forward, but in practice it is not very efficient for a number of reasons. First, a major inefficiency results from the fact that it is generally desirable to seal a number of joints in several different vaults and locations at about the same time so that only a single batch of sealing mix has to be created rather than creating a new batch each time a joint is ready to be sealed. This often results in a number of excavated areas being left opened (un-backfilled) until a desirable total number of such joints are ready to be sealed. This means that workers have to return to each inlet at a later time in order to backfill after the sealing has been done. Further, it causes a greater safety hazard as more excavated areas are left open for longer periods of time. A second source of inefficiency in this step of the process is the fact that the sealing compound (e.g. concrete) must be left to cure sufficiently prior to backfilling. If the concrete is not cured sufficiently, there is a risk displacing the uncured concrete and thus breaking the seal and allowing backfill to enter the vault. Thirdly, even when the concrete is allowed to sufficiently cure prior to back filling, often a certain amount of patching/parging must still be done on the inside to improve the quality of the seal. For all of these reasons, it is clear that it would be more efficient for workers to be able to backfill as they go, each time a pipe and inlet connection is made and prior to grouting or sealing. This is the need addressed by the present invention.

A number of prior art references related to catch basins and other vaults can be cited generally and specifically for addressing the need for improved means of joining piping or conduits to such vaults. Some examples are U.S. Pat. No. 3,973,783 (“Skinner”), U.S. Pat. No. 4,009,545 (“Rossborough”), U.S. Pat. No. 4,627,647 (“Hauff”), U.S. Pat. No. 4,732,397 (“Gavin”), and U.S. Pat. No. 5,340,166 (“Puttonen”).

A common solution for the need to seal a pipe joint is a gasket or elastomeric pipe collar type design. Skinner discloses an invention of this type. The device includes an annular body of rubber which is generally V-shaped in cross-section which defines inner and outer annular flanges. The annular body or rubber ring is fitted into the opening of a rigid concrete structure in an interlocking manner. This is achieved by providing the ring with an outer surface of keystone cross-section which is embedded into the concrete during casting. The rubber ring can then receive the pipe and the seal is tightened further by inserting a rubber wedge into the V-shape. This type of design is effective at sealing, but the need to embed the rubber ring into the concrete during casting increases manufacturing complexity and cost.

Rossborough's invention is an apparatus for pipe-to-manhole sealing wherein a port hole in a pre-cast concrete manhole is sealed by a flexible collar having one end clamped to the pipe and having a flange at the other end adhered to the riser around the cut hole. This design is effective at blocking the hole around the pipe but suffers from the need to have a ring clamp and is somewhat bulky.

Hauff teaches a wall feed-through fitting to allow a pipe to pass hermetically through a wall. While Hauff does not appear to have specifically designed this fitting for cast concrete distribution boxes, the need for sealing the annular open space between the pipe and the receiving hole is similar. This invention is a two piece solution to the problem—comprising an elastomeric adapter ring and a tightening ring that is inserted into the elastomeric ring. The elastomeric adapter sleeve has an outer surface engaging the wall surface, an inner surface snugly surrounding and engaging a pipe passing axially through the passage and an annular groove between the surfaces. A tightening ring of a radial dimension greater than the width of the groove fits so tightly in the groove as to press the sleeve radially outward against the surface of the passage and inward against the conduit. The ring is formed of at least two similar sector-shaped ring parts having the same radius of curvature as the groove and having ends provided with angularly interfitting formations. Thus the Hauff invention is a fairly sophisticated and costly solution to sealing a pipe to an aperture and is especially designed for situations when a tight fight is critical. Such tight-fitting seals are as critical in low pressure applications such as storm water management described above.

Gavin describes an improved cast concrete septic field distribution box. Gavin recognizes that the state of the art for sealing pipes to such boxes is a grouting procedure which he describes as “relatively slow and tedious”. His invention attempts to eliminate the need for grouting by providing an alternate sealing means. His solution is to use a seal and closure member of an elastomeric material that is mounted in the receiving holes of the distribution box. The seal comprises an annular elastomeric body portion having generally cylindrical inner and outer surfaces with the former defining a central cylindrical pipe receiving opening. The seal contains an annular flange which extends generally radially outward to be embedded in the cast cementious material about the box aperture—thus causing the body of the seal to fill up the open area between the pipe and aperture. This invention avoids the need for grouting, but at the expense of durability of the seal and increased complexity and manufacturing cost for the cast concrete boxes.

Puttonen relates to a conduit collar and method for installing the conduit collar in a circular hole through concrete and stone structures used in industrial construction work. The conduit collar includes at least one circumferential rib with an outer perimeter having a diameter larger than the diameter of the hole before the collar is installed into the hole. The outer perimeter of at least one of the circumferential ribs conforms to fit inside the hole when the collar is installed into the hole.

While all of these prior art inventions offer solutions for sealing the annular space between a pipe or conduit and its receiving aperture, none of these inventions simply, and at low cost, address the practical need for allowing an excavated area around a vault and its connection to be backfilled prior to grouting. Further, although some of these prior art designs may even avoid the need for grouting and thus allow an excavated distribution box to be backfilled immediately after pipe installation, they do so only by significantly adding to design complexity and cost. Thus, there continues to be a need for more efficient means for installing underground vaults such as those described herein.

Accordingly, it is an object of the present invention to provide a simple and relatively inexpensive means to allow an excavated area around an underground vault (e.g. a catch basin) to be backfilled prior to grouting around a connected pipe or conduit.

It is also an object of the invention to make the overall process of installing catch basins and other vaults more efficient by allowing backfilling to be done at anytime while still allowing the installer to perform grouting of multiple distribution boxes in a single batch.

It is still another object of the invention to allow an excavated area around a vault to be immediately backfilled after pipe installation without having to wait for concrete sealing compound to cure.

These and other objects are achieved by the present invention which is described more fully below.

### SUMMARY OF THE INVENTION

The invention is a pipe collar particularly for piping or conduits that connect to underground precast concrete catch basins or other vaults. The collar has an “L” shaped cross-section and is used in situations where loose fitting piping creates a roughly annular open section between the pipe and the opening receiving the pipe or conduit. The collar is installed around the pipe and flush with the outer wall of the inlet. When installed, the collar blocks the annular opening so that the area around the inlet and piping may be backfilled prior to the annular section being permanently sealed. At a convenient time after backfilling, a permanent seal (e.g. concrete mix or foam) can be put into the annular opening from inside the catch basin or other vault through access from an open top or other access means. In a preferred embodiment, the collar is made from a strip of plastic material having an “L” shaped cross section. A series of slices or serrations all along one branch of the “L” allows the strip to be easily wrapped into a circular shape during installation around the pipe with the unserrated side touching the pipe and the serrated side fanned out and flush against the vault exterior, thus helping to block the annular opening around the pipe.

### BRIEF DESCRIPTION OF THE DRAWINGS

FIG. 1 shows a prior art example of an uninstalled catch basin demonstrating the typical gap that appears between the piping and the aperture therefore.

FIG. 2 shows an embodiment of the pipe collar of the invention prior to being wrapped around a pipe.

FIG. 3 shows the pipe collar of the invention installed around a pipe and blocking the open annular area between the pipe exterior and the aperture.

### DETAILED DESCRIPTION OF THE INVENTION

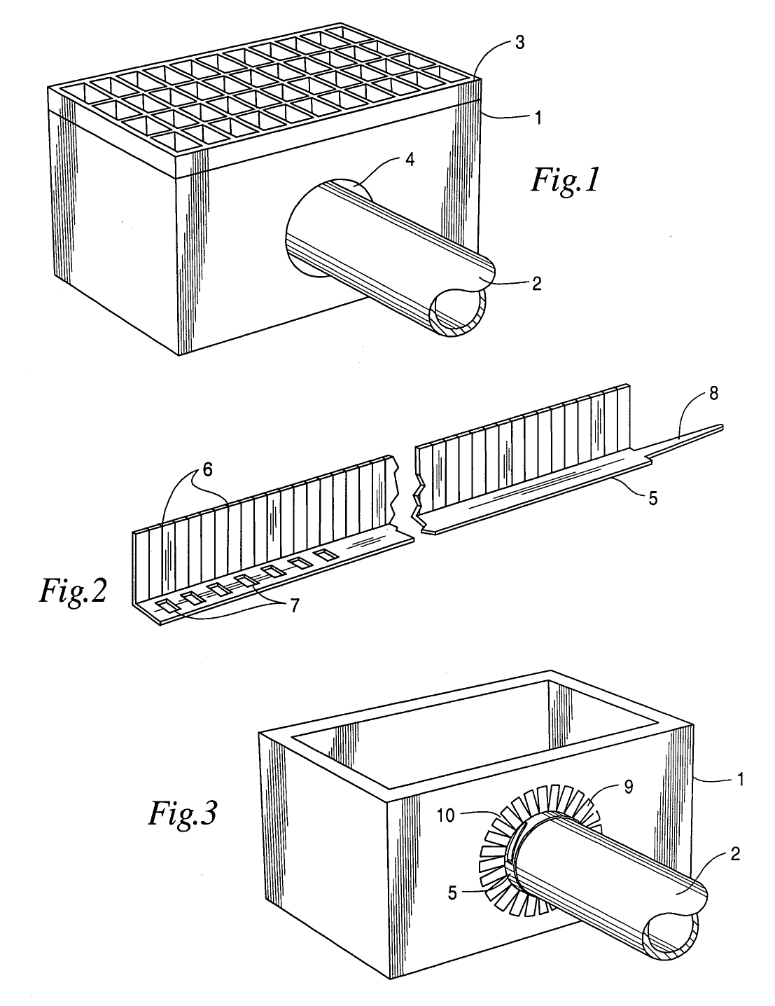

The invention is a pipe collar useful for improving the efficiency of connecting conduits or piping to underground vaults such as catch basins, manholes, and other fluid or cable receiving and distribution structures. An example of the type of vault structure the invention is useful with is shown in FIG. 1 (prior art) which depicts a storm water runoff catch basin 1. The catch basin is placed in an excavated area (not shown) underground with the grate 3 made approximately flush with the immediate surrounding. Storm water flows through the grate and is subsequently distributed through one or more pipes 2 for disposition of the storm water to a desired location. FIG. 1 shows the clearance gap 4 that occurs between the exterior of the piping and the hole in the side of the catch basin 1 for receiving the piping 2. This clearance can be 2 or more inches at some locations around the pipe. The gap results from the hole being made larger than the diameter of the pipe for ease of insertion and alignment adjustment of the pipe. The invention is designed to block, but not fill, most of this clearance.

FIG. 2 shows a diagram of the inventive pipe collar 5 in its uninstalled state. It comprises a long fairly straight strip of flexible material having an “L-shaped” cross section. “L-shaped” cross-section simply means that the cross-section has two branches connected to a common spine. The strip can be thought of as two long planar surfaces connected to each other at one of their long edges at a 90° or nearly 90° angle. The connection point of the two surfaces is referred to as the spine. The strip typically comprises a serrated surface or branch and a non-serrated surface or branch. However, the “non-serrated” side can have a small number of serrations to provide additional flexibility to the strip. This additional flexibility is especially useful in situations where the piping is not installed close to 90° from the aperture. The serrations can be made with a series of slits 6 from the outer edge thereof to near the spine. These slits 6 provide flexibility to the strip so that it can be collared around a pipe. FIG. 2 also shows the tab 8 at one end of the strip for insertion into one of the holes 7 near the other end to assist in maintaining the strip in a wrapped position.

FIG. 3 shows the catch basin or vault 1 of FIG. 1 with the pipe collar 5 of the invention installed around the pipe 2. The grate 3 has been removed simply to show a different view. The non-serrated surface lies generally flat against the pipe and the serrated surface has been fanned out as a result of the strip having been wrapped around the pipe. The teeth 9 of the fanned out surface blocks a substantial portion of the generally annular opening between the exterior of the pipe and the aperture in the box. The collar is held in position by the tab 8 connected to the opposite end of the strip. The collar thus positioned will prevent backfill from entering the box when the area around the pipe and box are filled with earth, aggregate or other backfill. Without the present invention, the annular opening 4 would have to be permanently sealed prior to backfilling (or temporarily sealed using a less convenient manner) or else backfill would be able to easily enter the vault.

The dimensions of the pipe collar can vary considerably. The length of the strip will be determined primarily by the circumference of the pipe or pipes that are to be collared. The length should be at least as long as the pipe circumference to provide adequate coverage of the open area around the pipe. In the embodiment shown in FIGS. 2 and 3 the strip is somewhat longer than the pipe circumference because the connecting means requires the collar to overlap itself so that the tab 8 can be received in a hole 7 on the other end of the strip. In another embodiment, the strip may be up to about twice as long as the pipe circumference to allow the collar to be wrapped more than once around the pipe. This double wrapping can provide even more coverage of the clearance 4 because the teeth 9 on the second wrap can cover the gaps 10 left between the fanned-out teeth 9 in the first wrapping.

In order for the collar to provide the best gap coverage, the width of the serrated surface (i.e. the radial length of the teeth) should be wider than the widest part of the clearance gap 4 between the exterior of the installed pipe and the aperture that receives it. In most cases the width of the serrated side will be from 4-12 inches and more typically will be from 6-8 inches. The width of the other surface that lies against the pipe is less critical. It must be wide enough to provide some stability or strength to the strip and to help the serrated surface of the collar stay flush against the exterior of the vault. Additionally, if the connecting means (discussed more fully below) is placed on this typically non-serrated surface, it must be wide enough to support such means. For these purposes, it is believed that a width in the range of 2-8 inches will be adequate, with a width of 4-6 inches presently preferred.

The term “serrated” as used herein means that one side of the “L-shaped” strip has a series of teeth substantially along its length. The primary purpose of the teeth is simply to provide the strip with the flexibility to wrap around a pipe. An “L-shaped” strip (having sufficient width to cover the gap described above) not having such teeth would not be flexible enough to wrap around a pipe unless it was made from an extremely elastic material which would be impractical for other reasons. The most preferred way of providing these teeth is to start with an “L-shaped” strip that has two unserrated surfaces and then making a series of slits 6 from one outer edge to a point near the spine. The angle to the spine at which the slits are made is variable. However, 90° is most practical but other angles can be used. The number of slits made, or the distance between slits, is also variable. When the strip is wrapped around a pipe the slits will create “V” shaped openings 10 as shown in FIG. 3. The main result of changing the distance between slits is the number and size of the resulting “V-shaped” openings. A greater distance between slits will result in fewer, but larger openings and a shorter distance will result in a greater number of smaller openings. In either case, the surface area of the slit openings will be the same. However, it is generally preferred to have a shorter distance between the slits since that will result in smaller holes 10 preventing more backfill of a smaller size from entering the vault. Thus, it is generally desirable to place the slits at a distance that provides holes 10 of about 1 inch or less. The distance between the slits will generally be from 2-8 inches, or more preferably 3-6 inches.

The material from which the invention is made is not, strictly speaking, a part of the invention, but it must have certain characteristics to make it suitable for the invention. The material must be flexible enough to allow the collar to be wrapped around a pipe once serrations have been made on one surface or branch of the “L-shaped” strip. The strip must also be rigid enough to stay in place once collared and to prevent backfill from entering the vault. Many plastic and metallic materials can meet these needs including aluminum, galvanized steel, polycarbonate, polystyrene, and polyethylene. Generally polymers are preferred due to their lower cost, simpler manufacturing techniques (sometimes), and longer lifetimes.

While the invention is generally described as a flexible strip, in a less preferred embodiment of the invention the collar is made from a series of approximately three curved, relatively inflexible segments. The joints between the three sections are flexible enough to allow the segmented strip to be wrapped around the pipe. The inflexible segments are designed to have a radius of curvature such that when the ends of the segmented strip are brought together the strip forms a circular opening approximately the diameter of the pipe the segmented strip is designed to fit. When the strip is placed around a pipe, the ends of the segmented strip can be fastened in a manner similar to the other embodiments and as furtrher discussed below. As in the embodiments previously discussed, each segment has an approximately L-shaped cross-section. However, in this embodiment each segment has its own flange for covering the annular space and no serrations on the flanges are needed. This embodiment is currently not preferred as it is anticipated to be more difficult to manufacture.

The collar of the invention typically has a connection means that will connect the strip to itself when the strip is wrapped around a pipe. FIG. 2 shows one example means of connecting the strip to itself. One end has a narrow tab 8 designed to be received by one of the holes 7 placed in the strip. In this example, simple friction holds the strip in the collared position. The connecting means need not be complex or strong as the collar merely needs to block the gap temporarily to allow the excavated area to be backfilled and until the permanent grout is put in place. One skilled in the art will understand that many other connection means are possible. Some additional examples include: VELCRO®-type fasteners, hook and hole, a rivet placed through overlapping holes, and strip type fasteners known as cable ties or zip ties. Further, in a preferred embodiment of the invention as shown in FIG. 2, the collar has multiple female connection points 7 along the strip thus allowing the collar to be used on different diameter pipes.

Another aspect of the invention is a method for improving the efficiency of installing vaults such as catch basins using the collar of the invention. This method comprises the steps of:
a) placing a vault in an excavated area, said vault designed to be installed underground and having one or more apertures for receiving a pipe or conduit;
b) installing a pipe or conduit in said one or more apertures thereby defining a roughly annular clearance gap between the exterior of said pipe or conduit and said aperture;
c) placing a collar around said pipe or conduit in a position to prevent backfill from entering the vault through the clearance gap;
d) backfilling around the pipe or conduit and vault; and
e) sealing the clearance gap via access from inside the vault.

In a preferred embodiment of this method, steps (a) through (d) are repeated multiple times for multiple vaults before step (e) is performed on any of the vaults. The clearance gap is sealed on multiple vaults in succession.

While the invention has been particularly shown and described with reference to preferred embodiments thereof, it will be understood by those skilled in the art that various alterations in form and detail may be made therein without departing from the spirit and scope of the invention. In particular, while the invention has been described with specific reference to storm water catch basins, the invention is useful with similar vaults that are installed underground and are used in the receiving and distribution of other materials including as sewage and also electrical or other cable.

1. A pipe or conduit collar for helping to prevent backfill from entering the clearance gap between said pipe or conduit and the aperture receiving said pipe or conduit, said collar comprising a flexible strip having a spine and two sides defining an L-shaped cross section; wherein at least one side of said collar is serrated to allow said collar to be wrapped around said pipe or conduit.

2. The pipe or conduit collar according to claim 1 additionally comprising a connection means for maintaining the strip in a wrapped position around the pipe or conduit.

3. The pipe or conduit collar according to claim 1 having one serrated side and one non-serrated side.

4. The pipe or conduit collar according to claim 1 wherein said serrations are formed by a series of slits along the length of the strip, said slits being from the outer edge to near the spine.

5. The pipe or conduit collar according to claim 4 wherein both sides of the L-shaped collar contain said slits.

6. The pipe or conduit collar according to claim 5 wherein on side contains said slits all along its length and the other side contains less than 5 slits

7. The pipe or conduit collar according to claim 4 wherein the slits are positioned at a 90° angle to the spine.

8. The pipe or conduit collar according to claim 4 wherein the slits are positioned at less than a 90° angle to the spine.

9. The pipe or conduit collar according to claim 1 wherein the connection means is capable of connecting the strip at a variety of positions for collaring pipes of different diameters.

10. The pipe or conduit collar according to claim 1 made of a material selected from the group consisting of aluminum, galvanized steel, and polymeric materials.

11. The pipe or conduit collar according to claim 1 wherein the connection means is selected from the group consisting of a hook and hole, overlapping holes for receiving a cable tie, hook and loop type fasteners, and tab and hole type fasteners.

12. The pipe or conduit collar according to claim 11 wherein the connection means comprises a tab on one end of the collar capable of being received in one or more receiving holes in the collar.

13. The pipe or conduit collar according to claim 12 having multiple receiving holes for allowing the collar to wrapped at different diameters.

14. A pipe or conduit collar for helping to prevent backfill from entering the clearance gap between said pipe or conduit and the aperture receiving said pipe or conduit, said collar comprising a flexible segmented strip having inflexible, curved segments with an L-shaped cross section; wherein said segmented strip forms a flanged collar when wrapped around said pipe or conduit.

15. A method of installing an underground vault containing one or more pipe or conduit connections, said method comprising:
a) placing a vault in an excavated area, said vault designed to be installed underground and having one or more apertures for receiving a pipe or conduit;
b) installing a pipe or conduit in said one or more apertures thereby defining a roughly annular clearance gap between the exterior of said pipe or conduit and said aperture;
c) placing a collar around said pipe or conduit in a position to prevent backfill from entering the vault through the clearance gap;
d) backfilling around the pipe or conduit and vault; and
e) sealing the clearance gap via access from inside the vault.

16. The method according to claim 15 wherein said vault is a catch basin.

17. The method according to claim 15 wherein said collar is the collar according to claim 1.

18. A method of installing an underground vault containing one or more pipe or conduit connections, said method comprising:
a) placing a vault in an excavated area, said vault designed to be installed underground and having one or more apertures for receiving a pipe or conduit;
b) installing a pipe or conduit in said one or more apertures thereby defining a roughly annular clearance gap between the exterior of said pipe or conduit and said aperture;
c) placing a collar around said pipe or conduit in a position to prevent backfill from entering the vault through the clearance gap;
d) backfilling around the pipe or conduit and vault;
e) repeating steps (a) through (d) for multiple vaults; and
f) sealing the clearance gaps via access from inside said vaults.

19. The method according to claim 18 wherein said vaults are catch basins.

20. The method according to claim 18 wherein said collar is the collar according to claim 1.
